(19) United States
(12) Patent Application Publication
(10) Pub. No.: US 2019/0027912 A1
(43) Pub. Date: Jan. 24, 2019

(54) Modular system for electrical and electronic distribution on stages

(71) Applicant: FABIO, BARI (IT)

(72) Inventor: Fabio Larizza, BARI (IT)

(21) Appl. No.: 16/070,823

(22) PCT Filed: Jan. 18, 2017
(86) PCT No.: PCT/IT2017/000006

§ 371 Date: Jul. 18, 2018

(30) Foreign Application Priority Data
Jan. 20, 2016 (IT) 102016000004910

(51) Int. Cl. H02G 3/38

(52) U.S. Cl. CPC H02G 3/385

(57) ABSTRACT

A modular system for electrical and electronic distribution on stages characterized by at least one rectangular or square base module (1), said module comprising a top layer (11) of polymeric material, a plate made of light metal alloy (12) being integral and interposed between the top layer of polymeric material (11) and a layer of polymeric material (13), and a bottom layer (14) of polymeric material engaged with the layer (13), a plurality of cables (2) being placed between the layers (13) and (14) through a prices of die casting, said cables (2) being adapted to distribute electric power and electronic signals between one end and the other one of the base module (1), the cables (2) comprising at least one line for the electrical distribution (20) whose terminal end are connected to a pair of connectors (5), a plurality of cables for the distribution of electronic signals (21) and at least one DMX cable (22) whose ends are connected to multipole connectors, the end of the cables (2) being integrally contained in a pair of recesses (15) and said base module comprising a longitudinal cavity (16) open on the bottom and adapted to integrally contain additional cables, and joining means (3) adapted to join at least two adjacent base modules.

The object of this invention refers to the field of those systems for setting up stage sets, and more particularly the invention relates to a modular system for electrical and electronic distribution on stages.

As known, within the term “stage craft” can be defined that technical knowledge adopted when stages, television sets, technical installations are set, as conceived for any other kind of public or private entertainment situation.

Preparing a spectacle requires a sequence of steps, which execution needs a certain amount of time and technical skills exercised only by qualified personnel. The latter must use a set of equipment, tools and accessories, which have to function with each other properly. More precisely, setting up a stage requires a number of assembly and dismantling operations for a plurality of elements with various typologies, shapes and dimensions, carried and mounted together adopting precise parameters and finally disassembled and re-organized in such a way as to make easier the next gig preparation.

In particular, at the end of the show the whole material on stage must be dismantled, arranged according to a certain accommodating arrangement and loaded on transport (usually trucks) that will bring the needed stuff at the warehouse for storage, otherwise toward the next destination where the stage will be set up again.

Consequently, the stage set-up operations result quite complex and require a sort of manuality to be implemented. Furthermore, it should be underlined as unless the operator is an organization offering the same kind of entertainment fitting in several places, it's quite impossible to predict what kind of layout will be adopted for each individual show. To compensate this variability of layouts, in order to accomplish the whole interconnection among every electrical and electronic equipment located over the stage, an articulated joint of floor cables can be employed, provided that every connection consists of electrical conductors with varying length.

Generally, the connections provided on stage can be organized into four categories:
Electrical connections that supply the electrical current to power devices;
Audio connections, arranged to transmit only audio signals, expecting these connections as audio-balanced (free from interferences over long distances);
Light connections dedicated to transmit DMX signals (an unique information protocol capable of coordinating the entire light apparatus, even if it's composed of different types of elements);
Other connections, i.e. non-DMX machinery controllers, video signal lines for projectors, digital Ethernet transmission data, power-audio connections, etc.

The adoption of floor cables presents a clear advantage or rather, in the event that one of these connections turns to be faulty or suffered damage during the installation or the same exhibition, a quick replacement with another similar and in good working condition one would be possible.

On the other hand, an adequately set stage must also comply with very specific aesthetic requirements, then hiding to the view every electrical conductor becomes important, especially in case of television coverages. However, the known type of floor cables may not be concealed correctly.

In view of the above, it's important to design the electrical connection layout on stages as tidily as possible, respecting both logical and practical criteria. It is also important to ensure that the electrical connections don't represent any kind of danger neither for professionals nor for the public: consequently it could be often difficult to dispose the whole arrangement of cables in such a way without obstructing the path to technicians. artists and spectators. Let's take for example the set of connections from the stage to the FoH (Front of House or also said Control Direction), usually located in front of the stage at safe distance; or the power cables going from frameworks near the stage, directly joined with fuel generators or cockpits in the floor at a very long distance. In all these cases, the use of modular cable ducts (mostly used in construction industry), designed with regard to strength and mechanical stability so that the passage of people, cars and trucks do not affect their integrity. On the other hand, solving with ducts can be expensive, bulky, heavy and uncomfortable to apply during assembly and dismantling. Their application is up to the installator, as already said, because these are designed to contain many general purpose connections, being although suitable to the show context.

About the electrical power supply for the stage: budgeted in excess, it is always provided as an absolute professional standard in the three-phase mode, from which it will be derived every single phase needed for the operation. As usually, this three-phase supply remains unchanged when delivered for the lighting system, while more likely the PA system (Public Address or Main Sound Reinforcement) and every single apparatus on the stage and in the FoH can be supplied with separate single-phase current. If the PA system were too much powerful in terms of power requirements, feeding with single-phase lines of 63 A is required, as on the stage will be possible to find single-phase 32 A lines. Differently, a single-phase line of 16 A will be enough to feed the whole FoH power requirement.

Therefore, it has shown that a common installation have significant execution times, also needed to organize the layout of the whole arrangement of floor cables. Similarly, the dismantling requires high execution times due to unraveling big wire tangles and the following rewinding of long cables.

Another problem encountered during the stage setting would be represented by the implementations of the so-called “stage box”, featuring a unique huge cable that contains a considerable amount of conductors, being able to transmit several tens of signals from the stage to the FoH and vice versa. This cable has necessarily a finite length and presents a fray of standard balanced connectors on its former termination, or alternatively a unique industrial connector disposed to the quick connection with the different apparatuses, while on the latter termination features a physical interface that includes every connection of its genre, in a complementar way to those on the fray. The only possible way to extend these connections is to joint them with other floor cables provided of balanced connection.

Every connection (both electrical or signal transmission) must be made according to a specific need: i.e. about electrical and lighting signal transmission, a power source can be represented by a female connector (receptacle or inlet), to avoid the danger of electrocution by contact, while the male connector is always found cm the side of fruition (plug); on audio connectors we find an output characterized by a plug and the receptacle for the circuit processing entrance, this for the practical reason to avoid accidental contact on input of amplifiers that will be reproduced as powerful and disturbing noises; the DMX line plugs are usually inverted for gender than the audio ones, and this permits a quick distinction among apparatuses and the cables here attached.

The main object of the present invention is to provide a modular system for setting up the stage in such a way to make assembly operations easier. and more particularly to simplify the cable path without the use of floor cables.

A further object of the present invention is to provide a modular system for setting up the stage reducing considerably the preparation and disassembly times with the aim of making this activity simpler and more comfortable to its dedicated operator.

Another further object of this invention is to provide a modular system for setting up the stage characterized by a plurality of modules, mutually connectable, constituting an alternative to the use of cable ducts designed to order, hide and contain safely every connection cable in the stage context.

A last object of the present invention is to provide a modular system to setting up the stage suitable in any situation or context referred to very small-sized stages (where just a bunch of cables would be enough) as for bigger, more complex situations where more modular systems must be employed in and independently. These—as well as other—purposes can be reached with the modular system for the electrical and electronic distribution on stages which is described below, with the help of the attached pictures that illustrate it in a typical application, without precluding further refinements in the scope of this invention:

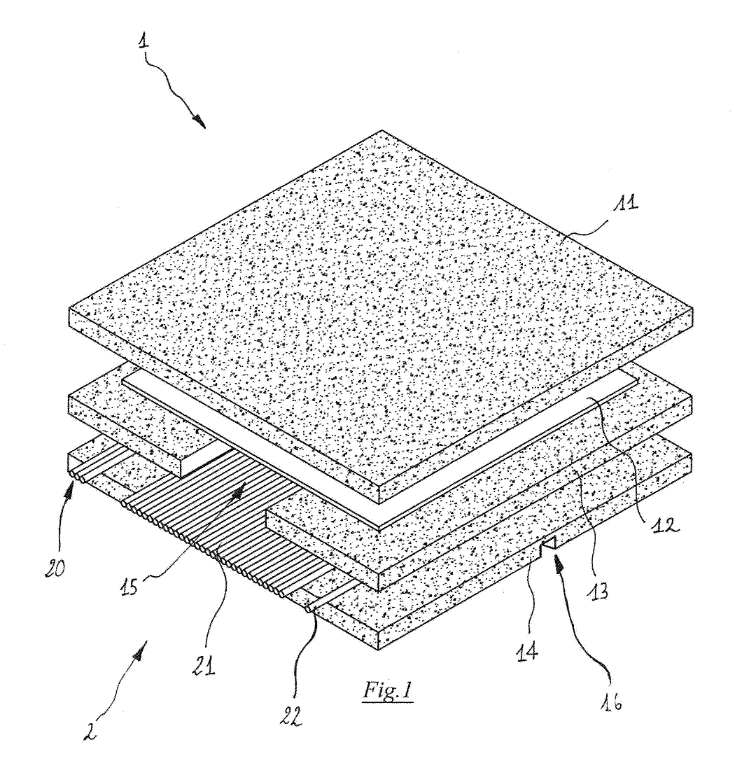

FIG. 1, an isometric view of the base module;

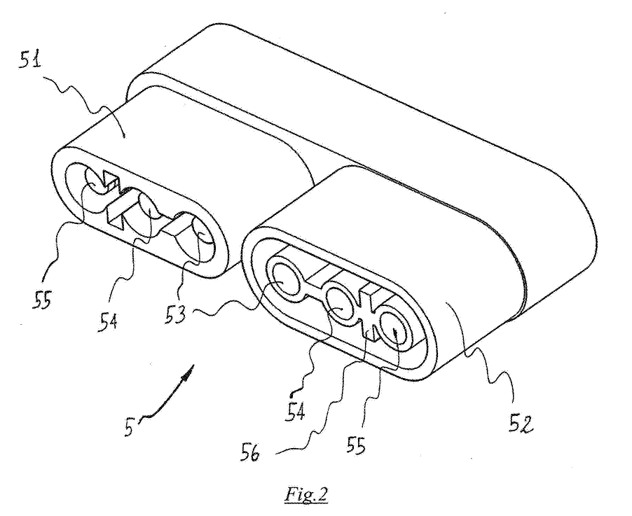

FIG. 2, an isometric view of the electrical connector;

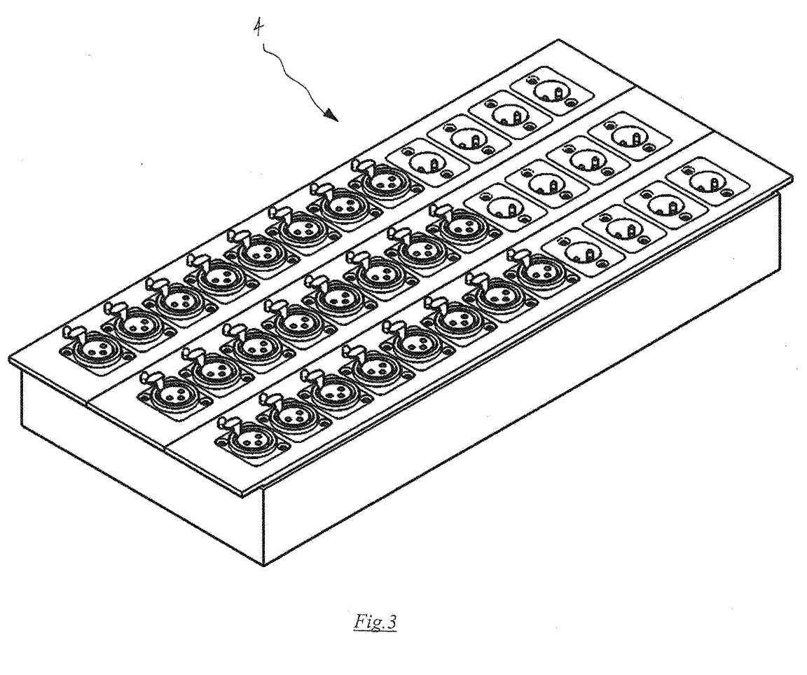

FIG. 3, an isometric view of the link interface;

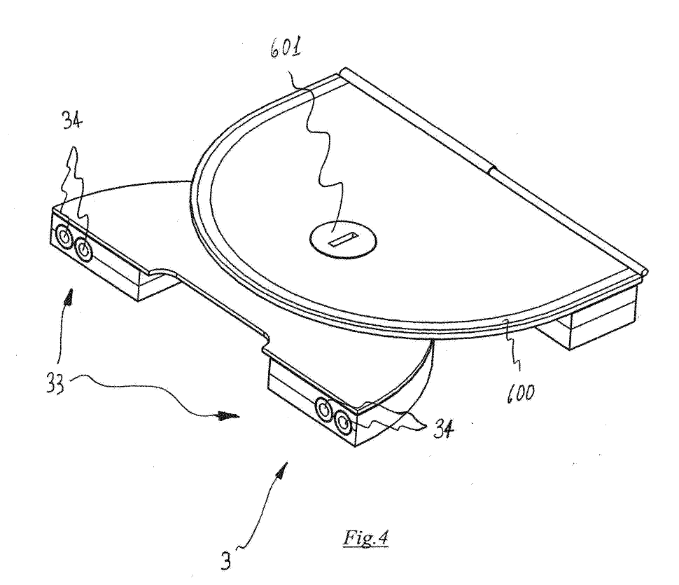

FIG. 4, an isometric view of the electromagnetic interlock mechanism;

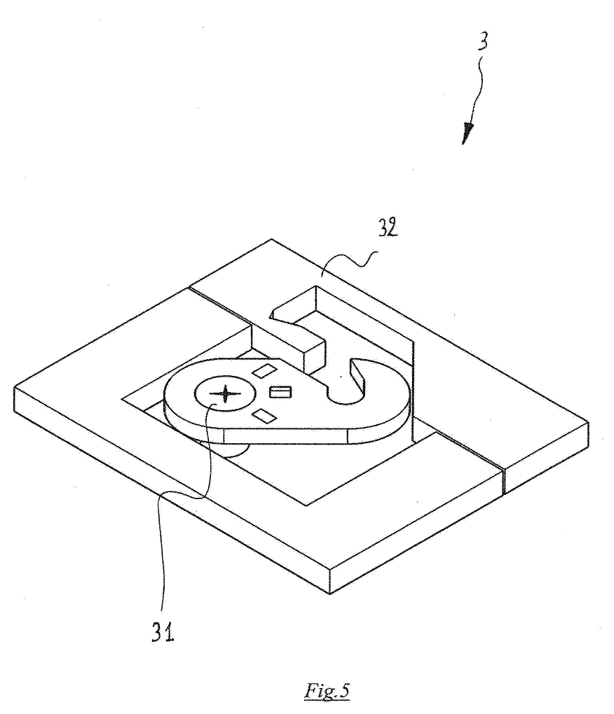

FIG. 5, an isometric view of the connection lock between each module and the other;

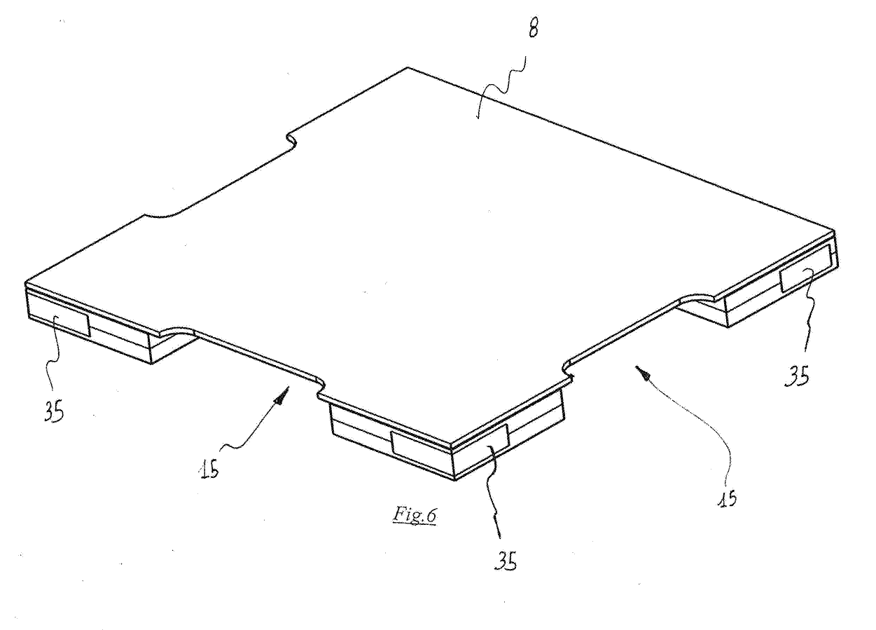

FIG. 6, an isometric view of the base module in an angular shape;

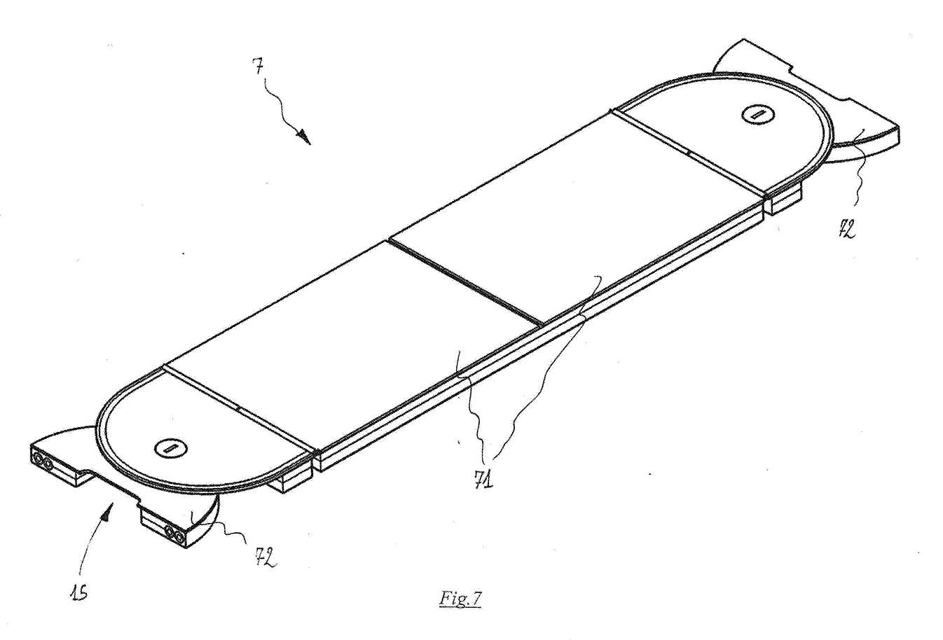

FIG. 7, an isometric view of the base module in a first shape, open;

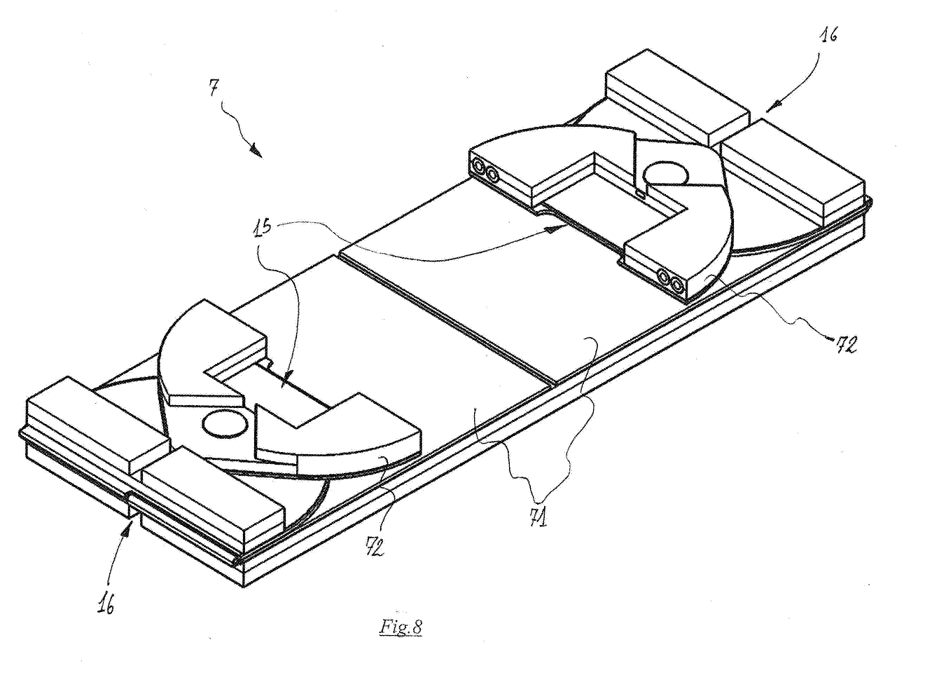

FIG. 8, an isometric view of the module in FIG. 7, closed;

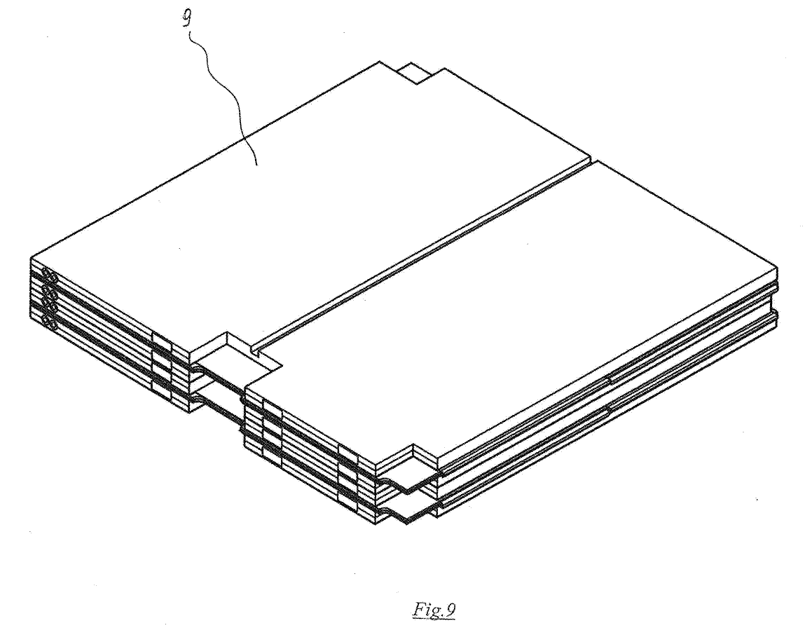

FIG. 9, an isometric view of the base module in a different shape, closed;

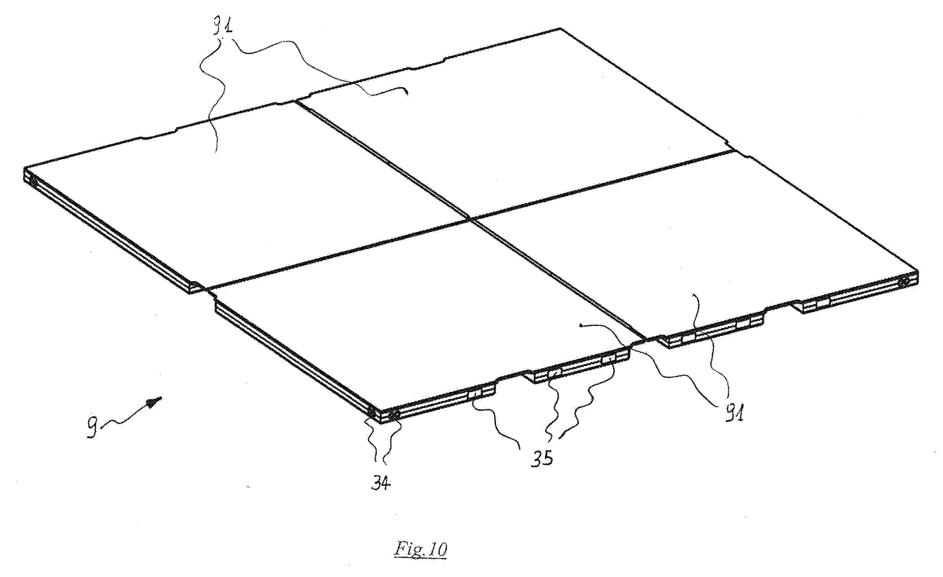

FIG. 10, an isometric view of the module in FIG. 9, open;

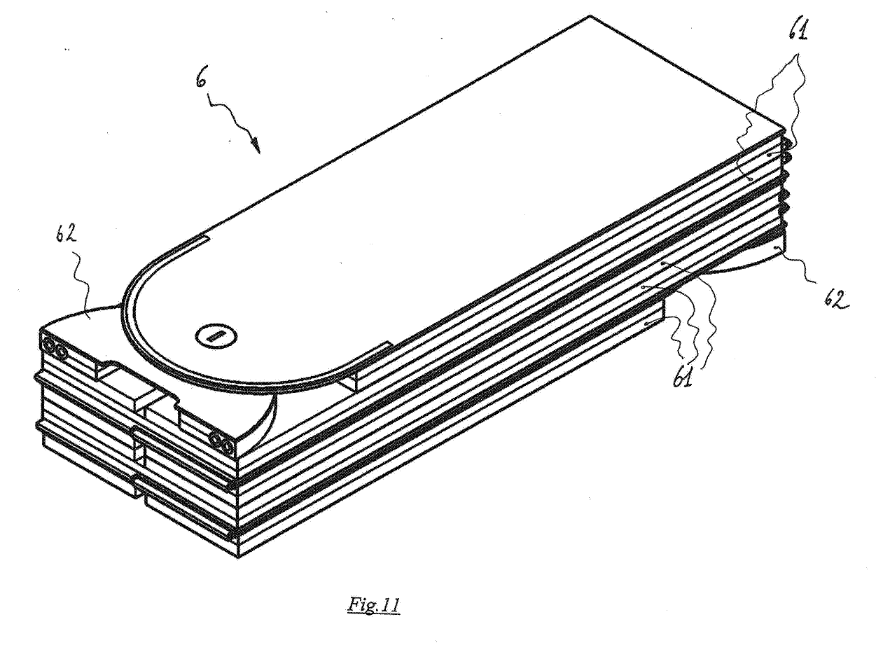

FIG. 11, an isometric view of the base module in another shape, closed;

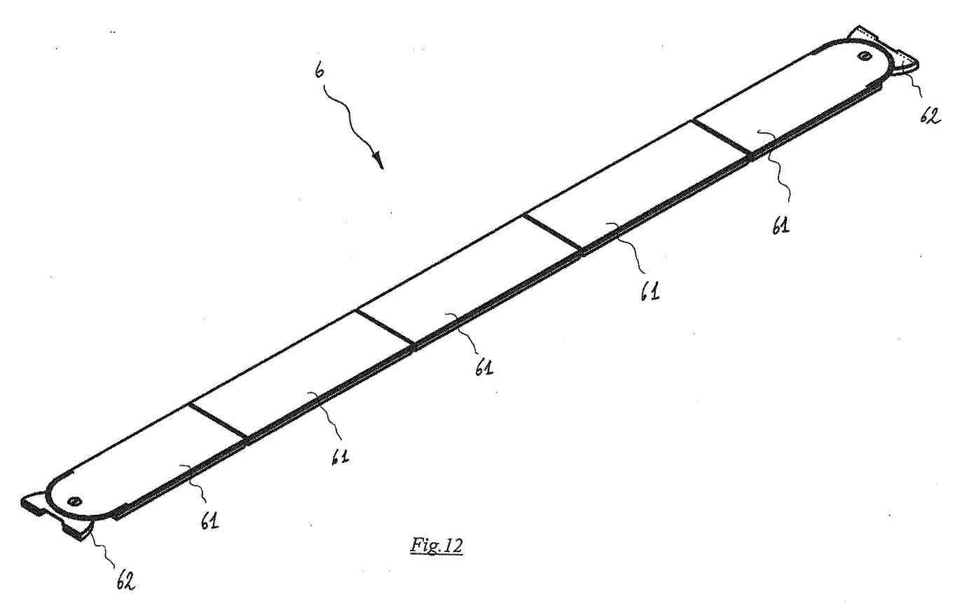

FIG. 12, an isometric view of the module in FIG. 11, open;

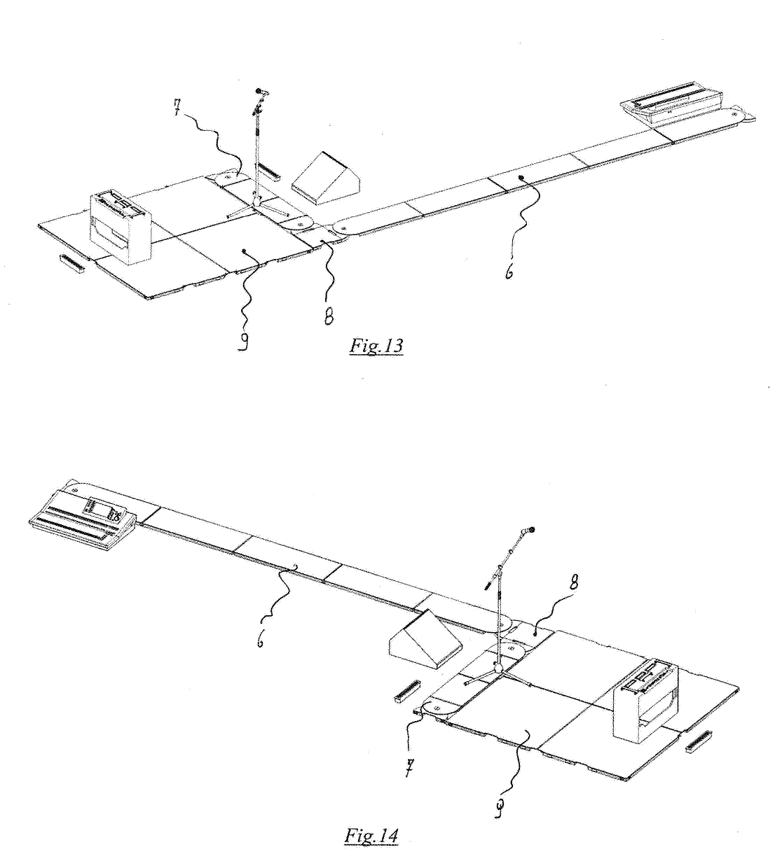

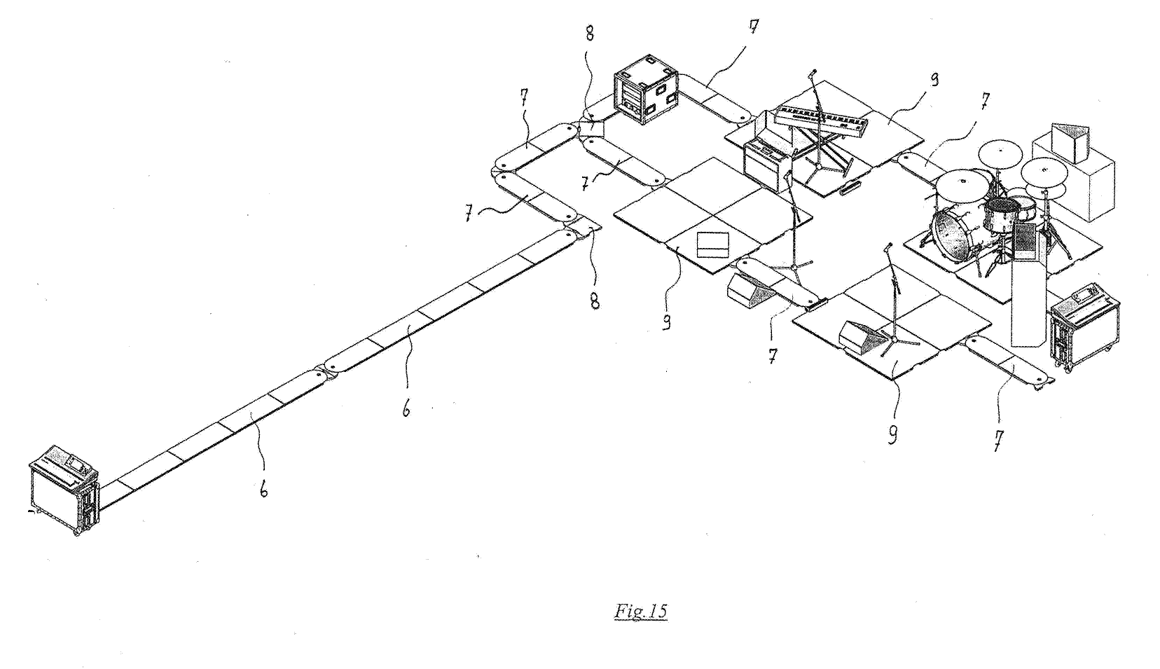

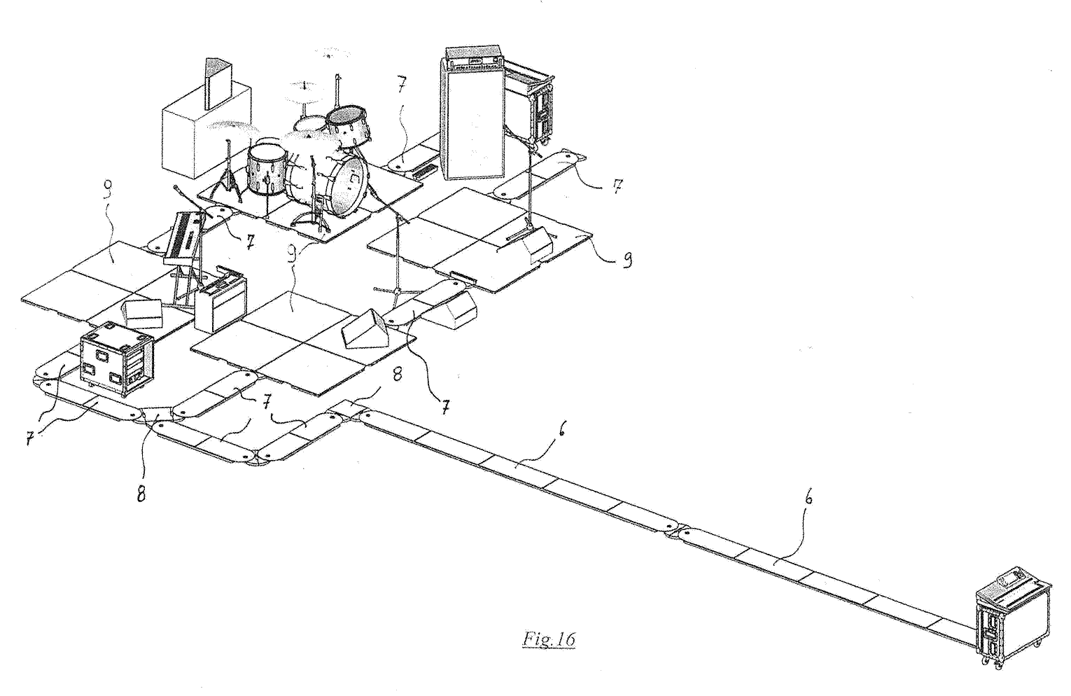

FIG. 13-16, isometric views of two different possible configurations of the system referred to this invention.

The modular system for the electrical and electronic distribution on stages referred to this invention features a square base module 1, which may take various configurations according to the stage layout needed. With reference to FIG. 1, the base module 1 may present a square or rectangular shape depending to the chosen configuration and consists of a plurality of layers, rigidly engaged among them and between which a plurality of cables 2 is contained for the electrical and electronic distribution. The cables 2 are located within each base module 1 by means of a die-casting process, being engaged inmovably.

Through the cables 2 the distribution of small electronic signals and bigger electrical currents from end to end of the base module 1 would be possible. The base module 1 can be placed on any type of flooring and, when the surface permits, the base module 1 can be firmly ensured with Velcro tape. In this case it would be better if this male Velcro splice is applied on the bottom of the base module 1 being reused at a later time on other surfaces like moquette. With the layer configuration shown, the composed base module 1 results vehicle proof, even for big, heavy vehicles and, of course, can be stepped by people.

The cables 2 inside the base module 1 are arranged in a row, adjacent to each other, and never overlapping (to keep it as thin as possible compromising in this way the planarity of the upper steppable surface of the base module 1. In this way, the cables 2 are protected from any kind of damage. The cables 2 can be in fixed number, i.e. 36 electronic balanced-type distribution cables and three electrical power connectors, assuming the same configuration adopted in most common stageboxes, and useful in most cases. In a first embodiment of the invention the base module 1 can include the cables 2:
an electrical distribution line 20, suitable to lead a potential force of 250V with 16 A of alternate current (but also 32 A), recognizable by a line cable (the single phase), a neutral wire and the larger ground conductor.
thirty-five electronic distribution cables 21, i.e. for specific audio purpose;
a DMX type cable 22;
other “Cat 5” cables;

This configuration is not limiting for the invention, which can have also different configurations, with a different number of cables than listed. The electronic distribution cables 2 can be grouped by eight, resulting organized in six different groups: each group is provided, on each end, of a multipole connector (not shown in the drawings) being composed by 24 metal pins.

The multipole connectors for signal cables 21 will be a variant of the “molex” connectors, sealed with watertight joints, heavy-duty and equipped with gold-plated contacts; in such a way, it will be a total number of 24 input and 12 output pin.

In detail, three of six groups presenting eight signal cables establish input, while the remaining three groups are provided as output. The DMX type cable 22 is provided in substitution to the thirty six audio-type missing cable: due to similar characteristics can be considered suitable for the same purpose, it's therefore up to the end user to decide which of the two features apply to the specific situation. We must remember that DMX type connection is always complementary to the audio connection, then we will consider a DMX line as a signal flow directed from the light console to the fixtures on the stage; if the audio feature is selected, this will be suited as audio console input.

Regarding to the base module 1, it includes an 12, possibly made of light alloy, interposed between two layers 11 of polymeric material and a 13, preferably of elastomeric material. The alloy metal plate 12 provides rigidity to the base module 1 and protects the underlying cables 2 when subjected to compression by heavy loads; furthermore it's always connected to a ground wire by means of a bolt. The ground wire is in turn connected with the ground potential on the main supply framework and with the metal chassis of the provided audio/DMX signal connectors (but can be disconnected from these when preferred).

Over the plate 12 there's a top layer 11 of polymeric material i.e. vulcanized rubber with high sulphur content, coating and protecting the plate 12 during compression and keeping the bearing surface rigid, in all those cases where it's necessary to stand on the module with heavy roller trunks expecting to avoid the minimum pitch.

Below the plate 12 there's a first layer 13 in polymeric material, i.e. isobutylene sheath, keeping separate the plate 12 from the underlying cables 2 and protecting both during a critical compression, while on the bottom layer 14 lie all the cables, being also the bottom of the whole module 1. Also this bottom layer 14 is made of polymeric material, i.e. isobutylene rubber. On the lower side of this layer a splice of male Velcro tape can be arranged with the aim to ensure tightly the base module 1 on the supporting floor below.

The plates 12 have a smaller extension than the adjacent polymeric layers 11 and 13 merged all together. In this way a segment composed by several modules joined together can be folded on itself allowing easier transportation and avoiding that the sharpen edges of the plate 12 can cause harm. On each base module 1 a recess 15 is provided on each end, in order to keep all the ends of the cables 2 hidden, and a longitudinal cavity 16, opened on the lower side of the layer 14, to use it as a duct for special cables, such as VGA, Ethernet and other non standard transmission lines, and preserving them in a safety position.

In order to realize the junction between more adjacent base modules 1. each module is provided of joining means 3. In a first embodiment of the invention, as shown in FIGS. 4 and 5, these joints 3 were accomplished by a simple mechanical hook lock 31 operable with a simple Phillips screwdriver on a complementary hooking receptacle 32. Each segment can be jointed to its similar both in lateral tiling (fitting the hook locks 31 and the receptacle 32) as in overlap.

In a different embodiment, the joints 3 can be obtained with an electromagnetic interlock mechanism 33. Between the layers 13 and 14, within each base module 1 lays a sealed PCB (printed circuit board) from which electrical power supplies can be derived. Printed on this PCB, a flat transformer provided of two ferrite valves and a common rectifier/regulator circuit gives dual 24 VDC as output potential. From the output utility lines are feeded until the termination angles of the module, where two solenoids 34 are coupled in polarity on each side (i.e. the North on the right side, the South on the left side). When the main power connection of the base module 1 is established with the framework, the solenoids 34 activate ensuring the magnetic clamping between the adjacent modules. There are some configurations where instead of solenoids it would be more appropriate to place a pair of small iron tabs or plates 35 merged with the modules. Furthermore, there can be a sliding switch on each swivel head to unlock the modules only in a specified point of the whole system, acting a localized intervention that doesn't require turning off the main current supply or preventing the complete release.

Another component of this system is constituted by a link and adaptation interface 4. The lines provided inside the various modules aren't provided of standard connectors commonly used in this field, and this for practical reasons: it's not said that for each segment would be necessary to derive every available connection. For a more congenial purpose, each termination is equipped of particular flat connectors which can be hidden, if necessary, in the recess 15 located on the same termination of the module 1. This solution is needed when a large number of cables 2 is brought up and transmitted within the module 1. Each segment can be connected with the previous and the next one.

When in proximity of any kind of catchment, and each time would be necessary to adopt a standard connection i.e. a standard “XLR Cannon” connector, the interface 4 can be employed, conveniently connected between a module and the other adjacent. On this interface, multipole input and output links can be accommodated underhead (lower side) issued with the module recesses 15 by means of the apposite openings.

Each module 1 features groups of cables 2, suitable depending to the requirements, while in regard of the interface 4, it is possible to inspect through the associated LEDs what connection group is being used or not, and possible defective lines. This solution is particularly suitable for any situation where connections are sorted out on different segment lines, and we need to know which of these connections are working in the module chain.

A further accessory item category is available, comprising any connection that inevitably needs to remain loosen (assuming the shortest length will be enough for the purpose). As visible in FIG. 3, the interface 4 includes both an input and an output for each cable 2 coming from the modules between which it is interposed. Furthermore, to the interface 4 various kinds of audio signals can be connected (from microphones as to monitor loudspeakers and DMX-protocol apparatuses). The interface 4 is a passive apparatus with the shape of a small box, with multipole inlets of the same kind of those applied to the ends of each segment. On the upper face of this box the standard balanced audio inlets are provided (male or female), necessary to plug in each microphone or loudspeaker, in such a way to keep the floor cables as shortest as possible or using special microphone stands with built-in cables. Across the interface 4, the input and output connectors go through each other (bridged) and the standard XLR connections are derived from this same bridge (paralleled).

Furthermore, for each standard input connection a LED is provided to turn on when a “Phantom” current supply is drained on that line. In this way, not only it is possible to check the correct working order of the whole system immediately after its composition, but it's also possible to know the exact path those lines are doing on the stage.

The present invention features also a connector 5 for the electrical line 20 only, specifically developed to adopt it among the modules referred to this invention. The connector 5, shown in FIG. 2, doesn't belong to a specific gender (male or female), since its characteristic is to incorporate both male and female characteristics. With the connector 5, every electrical connectors disposed, on the stage can be connected with any other identical connectors representing, in the same time, both a source and/or fruition energy point, depending on the case and the configuration required. This connector is designed to eliminate any sort of threat, for the installator (if properly used as a common power supply connector), and to meet the requirements of Class Protection IP67. Actually, when plugged to another identical connector, it remains immune from dust and temporary immersion, while when unplugged, must be sealed with the annex cover, being directly connected to the power source elsewhere.

To accomplish the linkage of this specific connector to the electrical supply, a simple but unique procedure is demanded (described later) with the purpose to make the safest possible main power arming. The connector 5 for bidirectional supply of the supply current features a male 51 and a female 52 connector positioned in perfect simmetry between them, enclosed in a protection barrier against accidental contact with their pin leads (the tip is covered by a cone shaped cover). The connector is specifically designed to allow the direct connection with another identical connector, dividing the total current distribution on both the two sides in uniform manner and giving protection from dust and liquids if dipped (in this way, the standard IP67 is fulfilled).

The disposition of the contacts within the connector is symmetrical; the line contact (single-phase) 53 is always in the inner, the ground contact 54 is at the center and the neutral contact 55 is on the outer edge. A special key 56 placed between the pin leads makes any accidental reverse connection impossible. The whole plug body can be made of isobutylene or vulcanized rubber.

In reference to the attached figures, the base module 1 can be employed in the following configurations: long transport configuration 6 with rectangular shape, covering a total distance of five meters and being constituted by five base modules 61, each one meter long, and being engaged at the short ends. On each short end can be placed an electrical power connector and six, group connectors for electronic signals (i.e. three 8-channel inputs and three 4-channel outputs). For this specific shape no further derivation for the power line are taken into account. This shape finds its main use with the transmission of signals from the stage to the FoH placed among, the audience or further, expecting that a only power current line will be enough to supply audio and light mixing desks, outboard racks and other apparatuses for the lighting. Furthermore a pair of these long transport modules 6 can be joint in a parallel displacement just doubling the number of available lines in transmission (resulting in 48 audio inputs where two will be DMX compatible, 24 audio outputs and two current lines and two different cavities 16 for specific types of cables).

This module shape features a swivel head for each short end. This module shape can be provided of hook locks 31 but also from a dedicated electromagnetic centralized system 33 per short end to which is attached a dedicated local release switch; the segment 6 always features an electrical power line with a potential of 250V flowing 16 A (or 32 A) in current and in option a common analog audio transport with 24 IN 12 OUT and a CAT5 Ethernet-type line for digital audio desks.

In a different embodiment of the present invention, the module 1 is in configuration of short transport 7, substantially the same as the previous for its rectangular shape, and designed to cover a total distance of 1.5 meters. This shape is accomplished when a pair of modules 71 are merged together while equipped with a pair of swivel heads 72. The short ends provide the same connectors of the previous module configuration 6, while from just one of the long sides can be obtained an electrical derivation in order to expand the possibilities of the energy supply on the stage. This kind of module shape can be employed in those situations where on the front line of the stage will be needed to supply current for the apparatuses of the singer and its monitor loudspeaker, following at the same time the distribution of electrical energy and electronic signal on the longer side of the stage, else in proximity to a walkway avoiding to interfere the path with floor cables.

For this segment shape the hook locks 31 as the electromagnetic centralized system 33 (with a release switch for each side) can be employed; as already said, it features an electrical power line with a potential of 250V flowing 16 A (or 32 A) of current with a side derivation and a common analog audio transport with 24 IN 12 OUT and an optional CAT6 Ethernet-type line for digital audio desks. In the case of the module shapes 6 and 7, the base modules are mutually engaged at the short ends with simple hinges at a well specified distance, in order to make a more easier and comfortable folding and transportation of the entire segment, but also to ensure adaptability when installed on irregular surfaces and floors. Both configurations, when closed, reach, a total length of one meter, in order to be stored with the maximum easiness. Close to the hinges, the top isobutylene layer presents reduced margins avoiding to counteract the backlash, keeping the outward protruding cables ensured in a further isobutylene sheath. The length of this exposed cable portion is displaced in such a way to permit a smooth, mess-free rotation of the hinges.

With reference to FIG. 4, the swivel heads 62 and 72 of the module shapes 6 and 7 are provided of arched metal cores 600, welded in adherence to the shape, making the heads stronger when subjected to compression.

The maximum tilt adjustment for the swivel heads 62 and 72 is 45° in both CW and CCW directions, with a total angle of 90°. The heads are pivoted to the base modules with a large radius bolt, adjustable from the top with a coney or a flat screwdriver, counteracted by two winch rods completely enclosed in the isobutylene rubber layer. For all those parts of the swivel head remaining suspended and susceptible by mechanical deformation when lacking of backings, there are some engageable prop (not shown) that can be adopted in form of clamps or neodymium magnets. Each connection line is die-casted to the modules, while the heads features a duct, with the aim of conveying all the lines and protruding them directly from the recess compartment. The cables exposed between the module and the swivel head are protected by further waterproof protective sheath.

Furthermore the swivel head presents an electrical release switch that interrupts the voltage feeding to the interlock solenoids only in the dedicated point, permitting a convenient access to the compartment and the joint connectors.

The unused connectors can be fixed on their dedicated housings (not shown), each one dedicated to its connector, directly formed on the elastomeric material of which the base module 1 is composed. The housings are located in the recess compartment under the short end of the swivel head. In a different embodiment of the present invention, the module 1 can be considered as angular transport 8 when shaped as a small square with the side of the same extension of the short end of the module shapes 6 and 7. Its function is limited to change the conduction angle of the path (and the connection, obviously), exactly of 90° for both its side directions. This can be employed to divert the path of the segments in the audience, but can be also adopted over the stage in particular conditions.

The module shape 8 is equipped of an input in form of analog audio transport and two side outputs displaced in right angle with the above mentioned input. An electrical line 20 with a potential of 250V flowing 16 A (or 32 A) is provided with two derivation plugs, each one displaced in the right angle with the former plug (getting a total of three plugs for three sides of the square, missing one side). Optionally, can be equipped also of a Cat. 5 Ethernet-type line used for digital desks (a center female input and two derived male outputs, one on each side in a right angle displacement with the former input).

It is noted that on this module shape 8 the electromagnetic centralized interlock mechanism isn't provided. The metal tabs 35 will replace its function in passive. coupling directly to the solenoids on the module shapes 6 and 7 that will result mechanically sealed to the module shape 8.

In a further embodiment of the present invention, the base module 1 can be employed in a larger squared shape 9. This configuration is composed by four base modules 91 mutually engaged, resulting useful mainly on the stage and especially on platform stands measuring two meters per side. It's suited to be placed under drumkits, percussion kits and large keyboard arrangements.

This kind of shape module is equipped with a main signal line with two all-inclusive side derivations (resulting in three parallel lines). The module is also equipped with an electrical line 20 with a potential of 250V flowing 16 A (or 32 A) of current with a derivation on each side of the square, no Cat. 5 Ethernet type cables (not indicated for its purposes) and four cavities on the bottom side of the base module.

This shape module features both active and passive interlocking systems: the passive with small metal tabs 35 to be locked with the modules 6 and 7, and the electromagnetic solenoids to be actively interlocked with other module shapes 9. This particular configuration appears to be congenial when placed under the drumkit, allowing the electrical derivation from the rear side for computers, sequencers, mixers and other apparatuses controlled by the drummer (obviously in rearguard position) as having the same function of the shape module 6 in the previously examined instance (providing electrical supply in the front space to the singer and feeding a monitor loudspeaker here placed).

The previously examined module shapes 6, 7, and 8 can provide, on the short end, a hook lock 31 and a receptacle 32, while the shape module 9 can be equipped of hook locks on each side. The shape module 8 can provide, on corners, a special lock mechanism composed by both genders (male and female), joined together at a right angle and with their respective receptacles facing outward.

In both the configurations 6 and 7, if the swivel heads 62 and 72 are equipped with the electromagnetic interlock mechanism 33, the modules engage each other through active magnetization.

In a different way, the module shapes 8 and 9 are interlocked with the module shapes 6 and 7 for passive magnetization only, by means of the small angular metal tabs 3 placed in the corner. In case if a pair of module shapes 9 would be needed, these will interlock together by active magnetization (solenoids to solenoids).

The module shapes 9, 8 and 7 previously described feature on the electrical line derivation a flat transformer and a rectifier/regulator circuit with a LED to indicate the presence of current and the activity of the electromagnetic interlock mechanism previously described.

At last, the solenoids featured with the module shapes 6, 7 and 9 are directly activated when a supply is provided to the segment. This supply can be locally disengaged acting on slide step-proof switches located on the swivel heads.

As shown in the Fig. from 13 to 16, these four module shapes obtained from particular arrangements of the base module 1 will be enough to fulfill any type of technical issue on any kind of stage, distributing signals and power lines towards in any direction needed.

Furthermore, the derivation circuits of the electrical line 20 can be achieved on printed boards with RoHS soldering. This board will be then enclosed and coated in the die-casting process with the isobutylene rubber during the production of the modules.

The audio signals can be practically derived on both ends of the whole series of the installed modules: an end will reach the FoH, the other one the stage control direction, totally avoiding the implementation of those typical and bulky stage boxes (these are characterized by finite length multicore cables, stage splitters to divide the signals for the two directions and the need to adopt uncomfortable cable ducts especially designed to be used in building industry). About the two terminations of the whole module chain, when completely constituted and installed on the stage, must be remembered that no interfaces will be provided (differently from what happens across the path): here can be applied a fringe of connectors in adaptation between the system connectors and those present as standard on any apparatus. These fringes complain to the following types:
FoH fringe: three male 24-pin multipole connectors and three female 12-pin multipole connectors on a termination; 24 XLR male connectors and 12 XLR female connectors on the other termination;
Stage fringe: three female 24-pin multipole connectors and three male 12-pin multipole connectors on a termination; 24 XLR male connector and 12 XLR female connectors on the other termination;

Also if (accidentally) the stage had been set up in a reverse way, by choice or by mistake, it will be enough to invert these two fringes to restore the optimal working order of the whole apparatus with no need to dismantle and redo the work all over again.

Finally, the system must include special signal extension cables (not shown) with male-female connectors to be used in substitution to the module shape 8 and whenever requested. These extension cables features a multicore of 24 signal lines grouped on three 24 pin connectors and 12 signal lines grouped on three 12 pin connectors, and an electrical line provided of the connectors 5. Furthermore, to feed the main supply from the framework to the whole system, a power cable with a connector 3 is provided and must be connected directly to the power source. The procedure previously mentioned consists in: plugging, carefully this specific cable (distinguishable i.e. by another sheath color) to the main source, being sure that no other electrical cable could be connected accidentally to another power source.

If it's not possible to put two modules beside each other, these would be overlapped. In this case, holes are provided for the affixing of self-tapping screws that will secure the seal.

Some utility adapters are provided too: these can be in form of short cables with a multipole connector (i.e. composed of 12 pin) on a termination and a group of four connectors XLR M on the other (or 24 pin on a termination with a group of eight XLR F) that substantially could replace the need to interpose an interface 4 in a specific point of the segment path on the stage if a consistent number of connections will be unnecessary; a ground connection decoupling adapter will also be provided to divide the ground connectors on the stage fringe, avoiding that the annoying phenomenon of “ground loop” occurs.

1. Modular system for electrical and electronic distribution on stages characterized by at least one rectangular or square base module (1), said module comprising, a top layer (11) of polymeric material, a plate made of light metal alloy (12) being integral and interposed between the top layer of polymeric material (11) and a layer of polymeric material (13), and a bottom layer (14) of polymeric material engaged with the layer (13), a plurality of cables (2) being placed between the layers (13) and (14) through a process of die casting, said cables (2) being adapted to distribute electric power and electronic signals between one end and the other one of the base module (1), the cables (2) comprising at least one line for the electrical distribution (20) whose terminal ends are connected to a pair of connectors (5), a plurality of cables for the distribution of electronic signals (21) and at least one DMX cable (22) whose ends are connected to multipole connectors, the end of the cables (2) being integrally contained in a pair of recesses (15) and said base module comprising a longitudinal cavity (16) open on the bottom and adapted to integrally contain additional cables, and joining means (3) adapted to join at least two adjacent base modules.

2. Modular system for electrical and electronic distribution on stages according to claim 1, wherein the cables (2) are arranged in a row, adjacent to each other, and never overlapping, and include a line for power distribution (20), adapted to conduct a potential of 250V at 16 A, and constituted by a phase wire, a neutral wire and a ground wire, thirty-five cables for distributing electronic signals (21), a DMX cable (22), the cables for electronic signals distribution (21) and the DMX cable (22) being grouped into groups, for a total of six groups and wherein each group is connected at the ends to a multi-polar connector composed of 24 pins made of metallic material.

3. Modular system for electrical and electronic distribution on stages according to claim 1, wherein the joining means (3) are constituted by a pair of hook locks (31) being manually operable and by a complementary hooking receptacle (32), the hook locks (31) and the hooking receptacle (32) being solidly connected to the opposite ends of each base module (1) so as to engage each module to the adjacent one both by lateral flanking and by overlapping through the union between the hook lock (31) and the hooking receptacle (32).

4. Modular system for electrical and electronic distribution on stages according to claim 1, wherein the joining means (3) are constituted by an electromagnetic interlock mechanism (33), said mechanism being contained within the base module, in particular between the layers (13) and (14), and comprising a junction box for additional electrical grid lines, upon which a flat transformer with two ferrite shells and a rectifier and leveller circuit with a dual 24 VDC output is photoengraved from which lines protruding at the ends of the module branch out, at the corners of said module two solenoids (34) are arranged, said solenoids being coupled by polarity on each side so as to guarantee the magnetic clamping between the adjacent modules.

5. Modular system for electrical and electronic distribution on stages according to claim 1, wherein the connector (5) is constituted by a male component (51) and a female component (52) arranged symmetrically to each other and being connectable with another connector (5), the electrical contacts of said connector (5) being arranged within the male component (51) and the female component (52) so as the phase (53) is in an inner position, the ground contact (54) in a central position and the neutral contact (55) in an external position and comprising, a key (56) between the phase and neutral leading wires of the male component (51) and adapted to be inserted into a corresponding cavity which the female component (52) is equipped with, of the corresponding connector with which it connects.

6. Modular system for electrical and electronic distribution on stages according to previous claims, wherein the top layer (11) of polymeric material, is made of vulcanized rubber with a high sulphur content, the plate of light metal alloy (12) is made of an aluminium alloy and the layers (13) and (14) are formed of an isobutylene sheath.

7. Modular system for electrical and electronic distribution on stages according to previous claims, characterized in that the base modules are five and rectangular-shaped, each module (61) being engaged at the short ends to the adjacent modules by means of hinges, and at the terminal ends there is a pair of swivel heads (62), each of said swivel heads comprising a power supply connector (5), multipole connectors for the conduction of electronic signals, and joining means (3).

8. Modular system for electrical and electronic distribution on stages according to claims from 1 to 6, characterized in that the base modules are two and rectangular-shaped, the modules (71) being mutually engaged at one short end by means of a hinge, and at the terminal ends there is a pair of swivel heads (72), each of said swivel heads comprising a power supply connector (5), multipole connectors for the conduction of electronic signals, and joining means (3).

8. Modular system for electrical and electronic distribution on stages according to claims from 1 to 6, characterized in that the base modules are two and rectangular-shaped, the modules (71) being mutually engaged at one short end by means of a hinge, and at the terminal ends there is a pair of swivel heads (72), each of said swivel heads comprising a power supply connector (5), multipole connectors for the conduction of electronic signals, and joining means (3).

9. Modular system for electrical and electronic distribution on stages according to claims from 1 to 6, characterized in that the base module is square-shaped (8), said module comprising three connectors (5) and multipole connectors for the conduction of electronic signals at three sides of the module and metal plates (35) at each corner.

10. Modular system for electrical and electronic distribution on stages according to claims from 1 to 6, characterized in that the base modules are four and rectangular-shaped, the modules (91) being mutually engaged at one short end and at one long end through a hinge, so as to constitute a single substantially square-shaped module, said module (9) comprising four connectors (5), each one situated at each side, and of multipole connectors of electronic signals on each side, and comprising metal plates (35) and joining means (3).
